(19) United States
(12) Patent Application Publication
(10) Pub. No.: US 2017/0187634 A1
(43) Pub. Date: Jun. 29, 2017

(54) Method for Transmission of Messages in a Computer Network and Computer Network

(71) Applicant: FTS Computertechnik GmbH, Vienna (AT)

(72) Inventors: Günter Bauer, Vienna (AT); Wilfried Steiner, Vienna (AT)

(21) Appl. No.: 15/386,442

(22) Filed: Dec. 21, 2016

(30) Foreign Application Priority Data
Dec. 23, 2015 (AT) A 51103/2015

(51) Int. Cl. H04L 12/853; H04L 1/00; H04L 12/891; H04L 29/08; H04L 7/00

(52) U.S. Cl. CPC H04L 47/2416; H04L 67/10; H04L 7/0012; H04L 47/41; H04L 1/0061; H04W 84/12

(57) ABSTRACT

The invention concerns a method for the transmission of messages in a computer network, wherein the computer network comprises nodes (101, 102, 103, 104, 101a, 101b, 102a), which are connected to each other by communication lines (110), e.g., in which each time two nodes are connected to each other, and wherein the nodes (101, 102, 103, 104, 101a, 101b, 102a) exchange messages with each other, and wherein data (D101, D102, D103) in the form of messages is communicated between the nodes, and wherein at least two first nodes (101, 102; 102, 103) send data (D101, D102; D102, D103) to a common second node (103; 104), wherein the computer network is designed such that at least one first node (102; 103) lies in at least one communication pathway of an additional first sending node (101; 102) or the plurality of additional first sending nodes to the common second node (103; 104), and wherein at least one first node (102; 103)—the so-called integration node (102; 103)—which is situated closer to the common second node (103; 104) than at least one other first node (101; 102) integrates the data (D101, D102) from at least one of the messages of the at least one node (101; 102) further removed from the common second node (103; 104) into at least one message generated by the integration node (102; 103), which this integration node (102; 103) sends to the common second node (103; 104), and wherein the at least one integration node (102; 103) for the purpose of this integration after the transmission of the proper integration node data (D102; D103) to be transmitted by it continues with the transmission of at least one message transmitting this proper integration node data (D102; D103), a so-called integration message, by inserting the data (D101, D102) being integrated of the at least one additional first node (101; 102) and/or fill data (S102) into this at least one message.

The invention concerns a method for the transmission of messages in a computer network, wherein the computer network comprises nodes, which are connected to each other by communication lines, e.g., in which each time two nodes are connected to each other, and wherein the nodes exchange messages with each other, and wherein data in the form of messages is communicated between the nodes.

Moreover, the invention concerns a computer network comprising nodes, which are connected to each other by communication lines, e.g., in which each time two nodes are connected to each other, and wherein the nodes exchange messages with each other, and wherein data in the form of messages is communicated between the nodes.

Furthermore, the invention also concerns a real-time computer system, especially a distributed real-time computer system, which comprises at least one communication system, which is configured in the form of an aforementioned computer network.

An aforementioned computer network forms for example the communication system for a distributed real-time system, or part of such a communication system.

Through the communication links, nodes can exchange messages, which messages can contain data.

Nodes can act as sender and/or receiver and/or relay points of messages.

Nodes can optionally execute functions, such as the measuring of properties of physical processes by means of suitable sensors—for which the nodes are connected to one or more sensors and/or contain such sensors—the computation of manipulated variables, or the activation of actuators, such as valves.

“Data” in the context of the present disclosure can mean data in the narrower sense, such as measured values, which are determined for example by the node or by sensors connected to the node, or the values of state variables, diagnosis values, and so on. But the data can also involve commands, such as control commands.

In general, “data” can contain identifiers, on the basis of which the receiver of the data knows, for example, which data is involved (data in the proper sense, commands in general, control commands, etc.). For this, it may be advantageous for the data to be designed as TLV triples (Type/Length/Value) triples, i.e., data is described by means of a type, a length and a corresponding value.

Inn the context of the present text, the yet to be described “fill data” does not come under the above described term “data” and thus is not “data” in the sense of the present text.

One problem which the invention intends to solve is reducing the transmission time for data in an aforementioned computer network.

This problem is solved with a method as mentioned at the outset in that, according to the invention, at least two first nodes send data to a common second node, wherein the computer network is designed such that at least one first node lies in at least one communication pathway of an additional first sending node or the plurality of additional first sending nodes to the common second node, and wherein at least one first node—the so-called integration node—which is situated closer to the common second node than at least one other first node integrates the data from at least one of the messages of the at least one node further removed from the common second node into at least one message generated by the integration node, which this integration node sends to the common second node, and wherein the at least one integration node for the purpose of this integration after the transmission of the proper integration node data to be transmitted by it continues with the transmission of at least one message transmitting this proper integration node data, a so-called integration message, by inserting the data being integrated of the at least one additional first node and/or fill data into this at least one message. The crux of the present invention is that messages can be altered during the relaying in a node, the so-called integration node. This affords an advantage over the prior art, with which the transmission time of the data can be significantly reduced, especially in a network of nodes. Thanks to this reduced transmission time, for example, production processes in existing real-time systems can be speeded up, and new applications for distributed real-time systems can be found.

Moreover, this problem is solved with an aforementioned computer network in that, according to the invention, at least two first nodes send data to a common second node, wherein the computer network is designed such that at least one first node lies in at least one communication pathway of an additional first sending node or the plurality of additional first sending nodes to the common second node, and wherein at least one first node—the so-called integration node—which is situated closer to the common second node than at least one other first node integrates the data from at least one of the messages of the at least one node further removed from the common second node into at least one message generated by the integration node, which this integration node sends to the common second node, and wherein the at least one integration node for the purpose of this integration after the transmission of the proper integration node data to be transmitted by it continues with the transmission of at least one message transmitting this proper integration node data, a so-called integration message, by inserting the data being integrated of the at least one additional first node and/or fill data into this at least one message.

According to the present invention, data from first nodes are transmitted by means of messages to a common second node. At least one of these first nodes according to the invention acts as an integration node, which integrates the data destined for the second node into a new message. For simplicity, in the context of the explanations of the invention the present text shall assume that messages which a first node sends contain only data destined for the common second node. But in reality, a message of a first node which contains data for a common second node can also contain other data, for example that which is already destined for the integration node, which then directly processes this, and/or data which is destined for the receiver situated downstream from the common second node. The integration node then integrates only that data which is destined for the common second node, according to the invention as described above, the remaining data from the message either being processed directly and/or relayed to the common second node, e.g., with the message by which it arrived at the integration node, and the common second node relays this message with the remaining data on to the final receiver.

The information exchange between nodes is message-oriented, for example, by means of Ethernet messages on wirelines or for example by means of messages per IEEE 802.11 on wireless communication links.

Advantageous embodiments of the method or the computer network according to the invention, which can be realized each in themselves or in any given combination with each other, are explained below:
fill data is integrated by a defined pattern into the at least one integration message. This defined pattern, especially a bit pattern, must be clearly recognizable as such at least by the last receiving node. This can be accomplished in that the nodes agree per configuration on a bit pattern. Ideally, it is a bit pattern which does not occur in the coding of the useful data, so that useful data cannot be mistaken for the bit pattern;
the data transmitted by the at least two first nodes and the common second node contains check sums. The check sum is preferably formed on the respective data;
the at least two first and the second nodes can transmit time-triggered messages, for example, they can transmit messages at configured moments of time in a global time;
sending nodes have the same moment of time configured for the transmission, preferably for the sending time, of at least one of their messages each time. It is advantageous for all nodes sending data to be synchronized with each other. The first nodes are sending nodes and are synchronized, the second receiving node can be the end point of the data transmission, in which case it need not be synchronized, or when it is itself the sender of data to the network it is advantageous for this second node to also be synchronized, i.e., when it begins to send messages at the same time as the first nodes;
the at least one integration node waits for a configurable or configured period of time and if within this period of time data from at least one additional first node begins to arrive, the integration node integrates this data into the message generated by it or begins to integrate it, preferably immediately after the proper integration node data or after fill data which follows the proper integration node data, and
if within this period of time no data begins to arrive from additional first nodes, the integration node terminates the message generated by it and transmits this to a receiver. The period of time is measured from the start of sending of the integration node message. The upper bound, i.e., the period of time for which the integration node is waiting, can be established, for example, by the maximum permissible length of the message which the integration node can send. In this connection, the case may arise in which a message with data arrives from a first node at the integration node shortly before reaching the maximum length of the message. In this case, the integration node can begin the integrating of data until the maximum length of the message is reached;
the at least one integration node integrates fill data arriving from at least one additional first node in the message generated by it, or preferably it does not integrate this fill data and discards it. The latter is possible, for example, when the temporal constellation of arriving data, fill data and outgoing generated message so permits.

In Ethernet the maximum message length is, for example, around 1518 Bytes, while there are also jumbo frames with, e.g., 9216 Bytes. But it could also be provided that the configured or configurable time period corresponds to only one Byte. Typical values for the time period thus correspond to a length of 1 Byte-1518 Bytes or 1 Byte-9216 Bytes.

It can also be provided that the time period corresponds to the precision of the synchronization, i.e., the maximum time difference between two nonfaulty local clocks in the nodes.

In the following, the invention shall be explained more closely with the aid of the drawing by means of a sample embodiment. There is shown

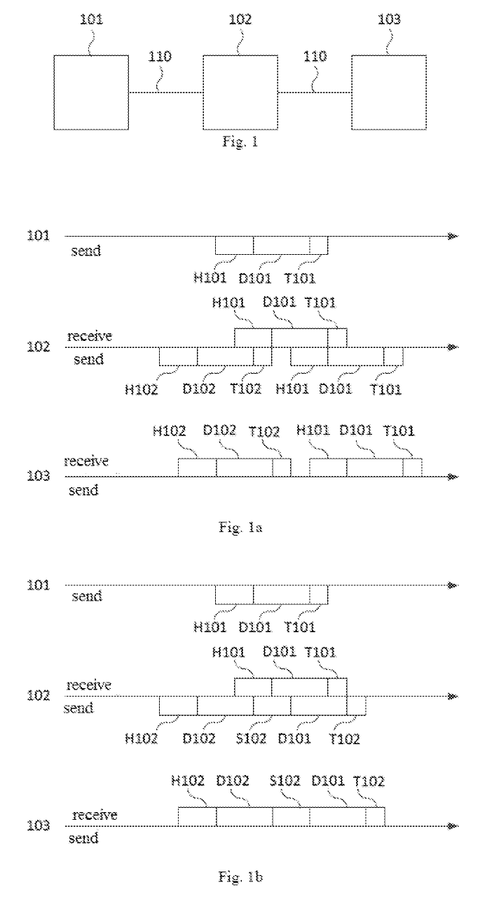

FIG. 1 a first schematic example of a simple computer network comprising three nodes,

FIG. 1a an example of a data transmission according to the prior art in the network per FIG. 1,

FIG. 1b an example of a data transmission according to the invention in the network per FIG. 1,

FIG. 1c a similar communication scenario to FIG. 1b,

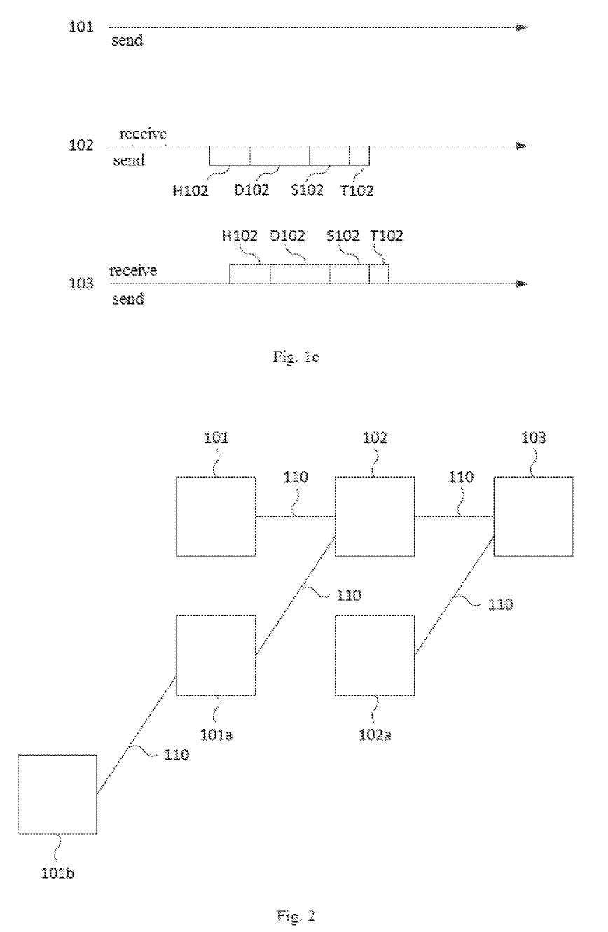

FIG. 2 a second schematic example of a simple computer network comprising six nodes,

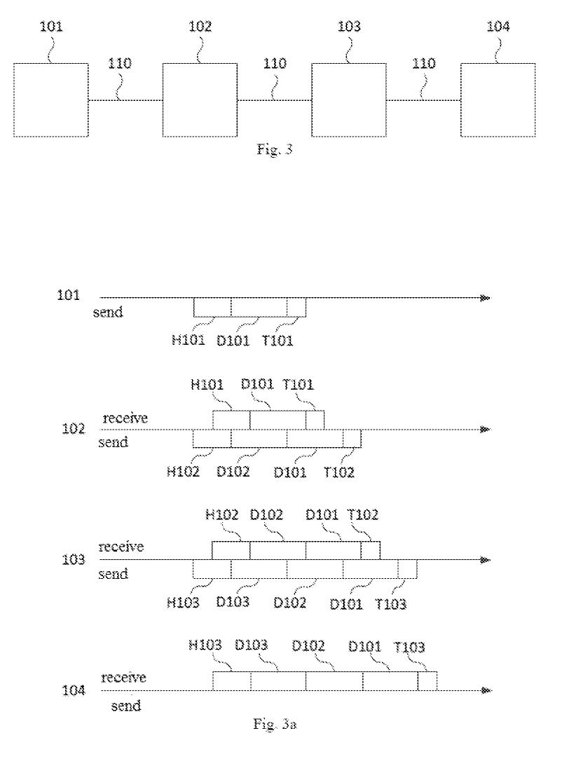

FIG. 3 a third example of a simple network with four nodes,

FIG. 3a an example of a data transmission according to the invention in the network per FIG. 3,

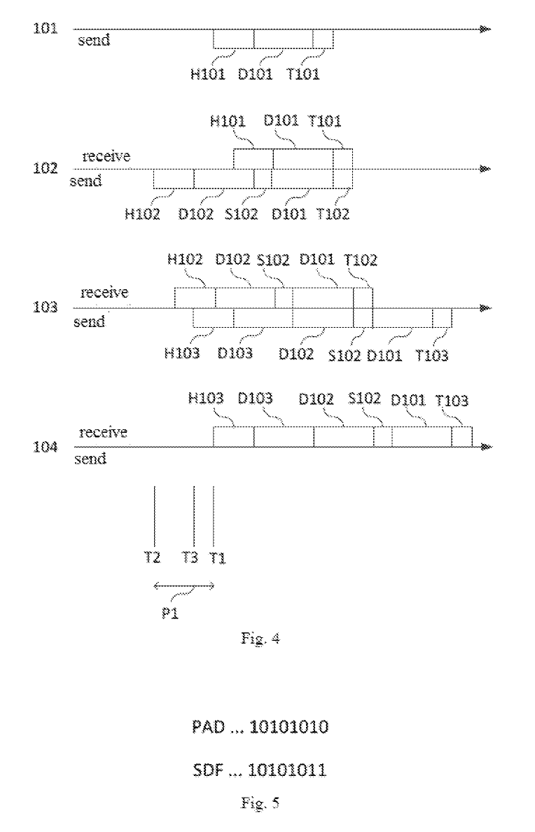

FIG. 4 a further communication scenario in a network per FIG. 3,

FIG. 5 an example of a pattern of fill data, and

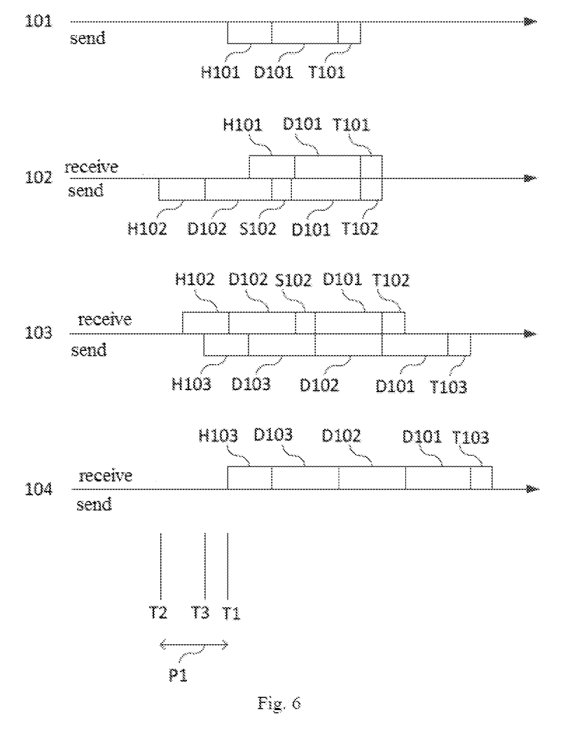

FIG. 6 a further communication scenario in a network per FIG. 3.

The networks described in the following each time comprise a number of nodes, the nodes being connected by means of communication links. The communication link between two nodes can be wireless or wireline, in the following examples we shall assume wireline, especially bidirectional wireline communication links.

FIG. 1 shows a first example of a network, which comprises nodes 101-103, being connected to each other as by wireline bidirectional communication links 110. Here, node 101 is connected to node 102 and this in turn is connected to node 103. Nodes can be connected to the surroundings by means of sensors. Nodes may exchange data among themselves, for example, current measured values of the sensors. For this, the data is packaged in messages and sent over the communication links.

In one special configuration of the network, a node, in this case node 103, acts as receiver and the other nodes 101, 102 as sender. Basically, nodes may act as sender, receiver, relay point, or as sender and relay point. Accordingly, relay points for example could also be arranged between the nodes, or the receiver 103 itself could again act as sender in a larger network. But this is not germane to the description of the invention, and for sake of simplicity we shall therefore only assume networks with senders and receivers.

FIG. 1a shows an example of a typical data transmission in the network per FIG. 1, showing the time along the abscissa. The two “first” nodes 101 and 102 send messages, which contain data D101, D102, to a common “second” node 103. The message of node 101 for example is composed of a message beginning H101, the data D101 being communicated from node 101, and a message end T101. The message of node 102 is composed of a message beginning H102, the data D102 being communicated from node 102, and a message end T102.

Specifically, for example, Ethernet can be implemented as the message-based transmission method. Ethernet comprises message structures like the following:
Message beginning H101, H102: Ethernet Header
Message data D101, D102: Ethernet Payload
Message end T101, T102: Ethernet CRC

As shown in FIG. 1a, node 101 sends the message consisting of H101, D101, T101 to node 102. Node 102 at first sends the message with “its” data D102, consisting of H102, D102, T102, to node 103 and after this it forwards the message of node 101, consisting of H101, D101, T101, on to node 103. Between the two messages, it may be necessary to observe a minimum distance between the sending processes. For example, in Ethernet the Inter-Frame Gap (IFG) is defined for this.

FIG. 1b shows a new kind of data transmission. Here, the same starting scenario is described as in FIG. 1: the “first” node 101 is supposed to transmit the data D101 to the node 103. The other “first” node 102 is supposed to transmit the data D102 to the “second” node 103. Unlike the scenario in FIG. 1a, one of the first nodes 102, namely that first node which is situated closest in the communication link to the common second node 103, the so-called integration node, performs an integration of the data D101 in message being transmitted by node 102 with the data D102 and thus transmits the data D101, D102 of the first two nodes 101, 102 in only one message to node 103. Specifically, node 101 sends its message consisting of H101, D101, T101 to node 102. This node, already before the start of the reception of the message of node 101, begins the sending of its message with “its” data D102. Node 102 therefore sends H102, D102, but does not end the transmission of its message at once after D102 with T102, and instead continues with the transmission of the message in that the node 102 inserts fill data S102 in the message. Once the data D101 of node 101 is ready for sending, possibly after suitable completion of the fill data S102, the node 102 can begin sending the data D101 by inserting it into the message being transmitted. After D101, the node 102 can wait for further data, possibly separated once more by fill data or (as shown in FIG. 1b) end the message with the message end T102.

Header H101 as well as the message end T101 of the message D101 will not be further sent, so that only part of the message transporting the data D101 need be sent further.

By the term “its” data or “the” data of a node is meant data having its origin in that node, either in that this node generates that data, or it comes from sensors connected to this node. Data coming from another node does not come under these terms.

FIG. 1c describes a similar communication scenario to FIG. 1b. The difference from the scenario in FIG. 1b consists in that the first node 101 sends no message to the common second node 103. As shown in FIG. 1c, the additional first node 102 sends a message to node 103, which contains H102, then the data D102, followed by fill data S102. After a certain time, which is preferably configured in advance, node 102 recognizes that no data is received from node 101, ends the writing of fill data S102 in the message, and terminates the message with the message end T102.

FIG. 2 shows a further example of a network in which nodes 101-103, 101a, 101b, 102a are connected to each other by communication links, such as by means of wireline bidirectional communication links 110. Nodes may be connected to the surroundings by means of sensors. Nodes may exchange data among themselves, for example, current measured values of the sensors. For this, the data is packaged in messages and sent by means of the communication links.

In the sample configuration of a network depicted, for example, one node, namely node 103, can act as “second” node, i.e., receiver, and the other nodes 101, 102, 101a, 101b, 102a act as sender, relay points, or sender and relay points. It might be provided in a first example that
the first nodes 101, 102, 101b send data to the common second node 103, while node 101a acts only as a relay point for messages from node 101b, and
node 102, which acts as an integration node by virtue of its position, integrates the data of nodes 101 and 101b destined for node 103 in an outgoing message from node 102 and sends this to node 103.

In a second example it might be provided that
the first nodes 101, 102, 101a send data to the common second node 103, and
the node 102, which acts as an integration node by virtue of its position, integrates the data of nodes 101 and 101a destined for node 103 in an outgoing message from node 102 and sends this to node 103.
node 101b hat in this example has no function according to the invention, for example it could send messages to a node (not shown) after node 103, while the nodes 101a, 102, 103 merely serve as relay points.

In a third example it might be provided that
the first nodes 101, 102, 101a, 101b send data to the common second node 103, and
the node 101a acts as an integration node and integrates the data of node 101b in an outgoing message from it, and
node 102 integrates the data of node 101 destined for node 103 and the data of node 101a and node 101b contained in the message of node 101a in an outgoing message from node 102 and sends this to node 103.

In a fourth example it might be provided that
the first nodes 101, 102, 101a, 101b, 102a, 103 send data to a common second node, not shown, and
node 101a integrates data of node 101b,
node 102 integrates data of nodes 101, 101b, 101a, and
node 103 integrates data of nodes 102, 101, 101b, 101a, and
transmits a message with the data of nodes 103, 102, 101, 101b, 101a to the second common node, not represented.

The examples given should be seen as being purely exemplary and explanatory, it being clear to the skilled person that there are still other possibilities of realization in the context of the invention, besides the four described above, and which are not described here for sake of brevity.

FIG. 3 shows another exemplary network similar to that of FIG. 1, now with four nodes 101-104, the nodes being connected in the series 101-102, 102-103, 103-104 by means of communication links, such as bidirectional communication lines 110.

FIG. 3a shows an exemplary communication scenario in a network with the topology of FIG. 3. The nodes 101, 102, 103 here are supposed to send data to the node 104 (receiver). In this example, the nodes 101, 102, 103 are synchronized with each other, so that they begin the respective message transmissions at the same time. As is shown, the two “first” nodes 101, 102 now send data D101, D102 with messages to the “second” node 103 which is common to both “first” nodes 101, 102. Node 102 here is closer to the “second” node 103 in the communication pathway of node 101 and thus acts as an integrator, i.e., node 102 integrates the data D101 of a first node 101 in the message by which the other “first” node 102 transmits “its” data D102 to the common node 103.

Node 102 and node 103 constitute “first” nodes for node 104, which in turn represents the common “second” node for these two “first” nodes 102, 103. Node 103 now integrates the data arriving from the message of node 102, i.e., the data D101, D102, as well as its data D103 in a common message, which message is sent by node 103 to node 104. Specifically, the common “second” node 103 integrates the data D101, D102 received with the message from node 102 in that message which it has begun to transmit at the same time as the beginning of the transmission of the messages of node 101 and node 102, and which contains its data D103, among others.

In this example, it is assumed that no fill data are needed. This may be the case, for example, when the receiver 104 is aware, already before receiving the message, how long the data D101, D102, D103 are, and it is ensured that the nodes 102, 103, which carry out the integration of the data, have each received the data D101, D102 being integrated in good time prior to the integration.

Node 103 thus sends a message with H103, D103, D102, D101, T103 to node 104, which receives this message somewhat later.

FIG. 4 shows another communication scenario in which nodes 101, 102, 103, 104 are arranged according to the topology in FIG. 3. Nodes 101, 102, 103 are supposed to send data to node 104. In this example, the nodes 101, 102, 103 are synchronized with each other, so that they begin the respective message transmissions at the same time. In this example, however, it is assumed that the synchronization is not perfect, so that the nodes are only approximately synchronized to each other. This means that, at each moment in real time, the local clocks of the nodes have a difference of at most P1 units of time from each other. Owing to the inaccuracy P1 of the synchronization, the nodes 101, 102, 103 begin the transmission of their data at different moments of time T1, T2, T3.

As shown, it may be necessary in this case for integration nodes during the relaying to insert fill data in those messages in which data from one or more of the other nodes is integrated, for example the integration node 102 inserts fill data S102 until such time as the data D101 of the other first node 101 begins to arrive at it, so that it can then integrate this, after the fill data S102, in the message by which it is transmitting its data D102 to the common second node 103. Thus, the fill data S102 is located between the data D101 and D102 in the message which node 102 transmits to node 103.

In the temporal constellation depicted, it is not necessary for the integration node 103 to also insert fill data D103, since at the time when its data is fully integrated in the message being transmitted data has already arrived at it with the incoming message from node 102, so that the integration node 103 can integrate, immediately after its data D103, the data D102, fill data S102 and D101 data from the message of node 102 in the message with its data D103.

Thus, the integration node 103 sends a message consisting of H103, D103, D102, S102, D101, T103 to node 104.

FIG. 5 shows one possibility of organizing the fill data S102. The fill data in this case is composed of a repetition PAD of “0” and “1” symbols, which can be continued for as long as desired. Optionally, a separation sequence SDF can be sent between the PAD fill data and the following data D101, D102, which clearly differentiates the end of the fill data S102 from the data D101, D102, D103. For this, it may be advantageous for the fill data to be designed as a TLV triple (Type/Length/Value), i.e., fill data is described by means of a type, a length, and a corresponding value.

FIG. 6 shows another communication scenario in which nodes 101, 102, 103, 104 are arranged according to the topology in FIG. 3. Nodes 101, 102, 103 are supposed to send data to node 104. In this example, the nodes 101, 102, 103 are synchronized with each other, so that they begin the respective message transmissions at the same time. In this example, however, it is assumed that the synchronization is not perfect, so that the nodes are only approximately synchronized to each other. This means that, at each moment in real time, the local clocks of the nodes have a difference of at most P1 units of time from each other. Owing to the inaccuracy P1 of the synchronization, the nodes 101, 102, 103 begin the transmission of their data at different moments of time T1, T2, T3.

As shown, it may be necessary in this case for integration nodes during the relaying to insert fill data in those messages in which data from one or more of the other nodes is integrated, for example the integration node 102 inserts fill data S102 until such time as the data D101 of the other first node 101 begins to arrive at it, so that it can then integrate this, after the fill data S102, in the message by which it is transmitting its data D102 to the common second node 103. Thus, the fill data S102 is located between the data D101 and D102 in the message which node 102 transmits to node 103.

In the temporal constellation depicted, it is not necessary for the integration node 103 to also insert fill data, since at the time when its data D103 is fully integrated in the message being transmitted data has already arrived at it with the incoming message from node 102. In fact, it is even possible for the integration node 103 in the depicted temporal constellation to again discard the fill data S102 during the integration, so that the integration node 103 can integrate, immediately after its data D103, the data D102 and data D101 from the message of node 102 in the message with its data D103.

Thus, the integration node 103 sends a message consisting of H103, D103, D102, D101, T103 to node 104.

The data D101, D102, D103 being transmitted can optionally contain a check sum, for example, a Cyclic Redundancy Check. A receiver of the data can identify transmission errors according to the check sum. In this way, the invention makes it possible for a receiver 104 to utilize the data D101, D102, D103 without having to wait for the message end T103.

1. A method for the transmission of messages in a computer network, wherein the computer network comprises nodes (101, 102, 103, 104, 101a, 101b, 102a), which are connected to each other by communication lines (110), e.g., in which each time two nodes are connected to each other, and wherein the nodes (101, 102, 103, 104, 101a, 101b, 102a) exchange messages with each other, and wherein data (D101, D102, D103) in the form of messages is communicated between the nodes, and wherein
at least two first nodes (101, 102; 102, 103) send data (D101, D102; D102, D103) to a common second node (103; 104), wherein the computer network is designed such that at least one first node (102; 103) lies in at least one communication pathway of an additional first sending node (101; 102) or the plurality of additional first sending nodes to the common second node (103; 104), and wherein
at least one first node (102; 103)—the so-called integration node (102; 103)—which is situated closer to the common second node (103; 104) than at least one other first node (101; 102) integrates the data (D101; D102) from at least one of the messages of the at least one node (101; 102) further removed from the common second node (103; 104) into at least one message generated by the integration node (102; 103), which this integration node (102; 103) sends to the common second node (103; 104), and wherein the at least one integration node (102; 103) for the purpose of this integration after the transmission of the proper integration node data (D102; D103) to be transmitted by it continues with the transmission of at least one message transmitting this proper integration node data (D102; D103), a so-called integration message, by inserting the data (D101; D102) being integrated of the at least one additional first node (101; 102) and/or fill data (S102) into this at least one message.

2. The method of claim 1, wherein fill data (S102) is integrated by a defined pattern (PAD, SDF) into the at least one integration message.

3. The method of claim 1, wherein the data (D101, D102, D103) transmitted by the at least two first and the common second nodes contains check sums.

4. The method of claim 1, wherein the at least two first and the common second nodes (101, 102, 103) can transmit time-triggered messages, for example messages at configured moments of time (T1, T2, T3) in a global time.

5. The method of claim 4, wherein sending nodes (101, 102, 103) have the same moment of time (T1, T2, T3) configured for the transmission, preferably for the sending time, of at least one of their messages each time.

6. The method of claim 1, wherein the at least one integration node (102; 103) waits for a configurable or configured period of time and
if within this period of time data (D101; D102) from at least one additional first node (101; 102) begins to arrive, the integration node (102; 103) integrates this data (D101; D102) into the message generated by it or begins to integrate it, preferably immediately after the proper integration node data (D103) or after fill data (S102) which follows the proper integration node data (D103), and
if within this period of time no data (D101; D102) begins to arrive from additional first nodes (101; 102), the integration node (102; 103) terminates the message generated by it and transmits this to a receiver (103; 104).

7. The method of claim 1, wherein the at least one integration node (102; 103) integrates fill data (S102) arriving from at least one additional first node (101; 102) in the message generated by it, or preferably it does not integrate this fill data.

8. A computer network comprising:
nodes (101, 102, 103, 104, 101a, 101b, 102a), which are connected to each other by communication lines (110), e.g., in which each time two nodes are connected to each other, and wherein the nodes (101, 102, 103, 104, 101a, 101b, 102a) exchange messages with each other, and wherein data (D101, D102, D103) in the form of messages is communicated between the nodes, and wherein
at least two first nodes (101, 102; 102, 103) send data (D101, D102; D102, D103) to a common second node (103; 104), wherein the computer network is designed such that at least one first node (102; 103) lies in at least one communication pathway of an additional first sending node (101; 102) or the plurality of additional first sending nodes to the common second node (103; 104), and wherein
at least one first node (102; 103)—the so-called integration node (102; 103)—which is situated closer to the common second node (103; 104) than at least one other first node (101; 102) integrates the data (D101; D102) from at least one of the messages of the at least one node (101; 102) further removed from the common second node (103; 104) into at least one message generated by the integration node (102; 103), which this integration node (102; 103) sends to the common second node (103; 104), and wherein
the at least one integration node (102; 103) for the purpose of this integration after the transmission of the proper integration node data (D102; D103) to be transmitted by it continues with the transmission of at least one message transmitting this proper integration node data (D102; D103), a so-called integration message, by inserting the data (D101; D102) being integrated of the at least one additional first node (101; 102) and/or fill data (S102) into this at least one message.

9. The computer network of claim 8, wherein fill data (S102) is integrated by a defined pattern (PAD, SDF) into the at least one integration message.

10. The computer network of claim 8, wherein the data (D101, D102, D103) transmitted by the at least two first and the common second nodes contains check sums.

11. The computer network of claim 8, wherein the at least two first and the common second nodes (101, 102, 103) can transmit time-triggered messages, for example messages at configured moments of time (T1, T2, T3) in a global time.

12. The computer network of claim 11, wherein sending nodes (101, 102, 103) have the same moment of time (T1, T2, T3) configured for the transmission, preferably for the sending time, of at least one of their messages each time.

13. The computer network of claim 8, wherein the at least one integration node (102; 103) waits for a configurable or configured period of time and
if within this period of time data (D101; D102) from at least one additional first node (101; 102) begins to arrive, the integration node (102; 103) integrates this data (D101; D102) into the message generated by it or begins to integrate it, preferably immediately after the proper integration node data (D103) or after fill data (S102) which follows the proper integration node data (D103), and
if within this period of time no data (D101; D102) begins to arrive from additional first nodes (101; 102), the integration node (102; 103) terminates the message generated by it and transmits this to a receiver (103; 104).

14. The computer network of claim 8, wherein the at least one integration node (102; 103) integrates fill data (S102) arriving from at least one additional first node (101; 102) in the message generated by it, or preferably it does not integrate this fill data.

15. A real-time computer system, especially a distributed real-time computer system, which comprises at least one communication system, wherein the at least one communication system is configured as the computer network of claim 8.
